(19) United States
(12) Patent Application Publication
(10) Pub. No.: US 2001/0018132 A1
(43) Pub. Date: Aug. 30, 2001

(54) Method for producing very thin ferroelectric layers

(76) Inventors: Walter Hartner, Munchen (DE); Gunther Schindler, Munchen (DE)

Correspondence Address: LERNER AND GREENBERG, P.A., POST OFFICE BOX 2480, HOLLYWOOD, FL, 33022-2480, US

(21) Appl. No.: 09/790,935

(22) Filed: Feb. 22, 2001

(30) Foreign Application Priority Data
Feb. 22, 2000 (DE) 100 09 146.6

(51) Int. Cl. B32B 9/00

(52) U.S. Cl. 428/469; 428/472; 428/701

(57) ABSTRACT

A metal-oxide-containing, in particular ferroelectric, layer is deposited on a substrate and is crystallized by a first thermal treatment at approximately 800° C. The cavities formed by the heat-treatment process are filled by a subsequently applied filling solution, which contains substantially the same constituents as the metal-oxide-containing layer. The filling layer is subsequently crystallized during a second thermal treatment. The metal-oxide-containing layer thus combines a low coercive field strength with a high remanent polarization and a high breakdown voltage. A microelectronic structure is also provided.

### BACKGROUND OF THE INVENTION

1. Field of the Invention

The invention relates to a method for producing a polycrystalline metal-oxide-containing layer. In particular, the invention relates to a method for producing a ferroelectric or paraelectric layer which can be used as a dielectric for a semiconductor memory.

Conventional microelectronic semiconductor memory devices, such as DRAMs (Dynamic Random Access Memory), are essentially formed of a selection or switching transistor and a storage capacitor. The storage capacitor has a dielectric material provided between two capacitor plates. Usually, oxide or nitride layers having a dielectric constant of at most about 8 are mainly used as the dielectric. In order to reduce the size of the storage capacitor and in order to produce non-volatile memories, “novel”capacitor materials (ferroelectrics or paraelectrics) having distinctly higher dielectric constants are needed. A few of these materials are mentioned in the publication “Neue Dielektrika für Gbit-Speicherchips [New Dielectrics for Gbit Memory Chips]” by W. Honlein, Phys. B1. 55 (1999).

In order to produce ferroelectric capacitors for applications in non-volatile semiconductor memory devices having a high integration density, it is possible to use e.g. ferroelectric materials such as SrBi₂(Ta,Nb)₂O₉ (SBT or SBTN), Pb(Zr,Ti)O₃ (PZT), or Bi₄Ti₃O₁₂ (BTO) as dielectric between the capacitor plates. However, it is also possible to use a paraelectric material, such as (Ba,Sr)TiO₃ (BST) for example. SBT (strontium bismuth tantalate) and SBTN (strontium bismuth tantalate niobate) are approximately in the range from 80 to 90 kV/cm (SBT) and 140 kV/cm (SBTN). With a layer thickness of 180 nm that is customary at the present time, this corresponds to a voltage of approximately 1.6 V (SBT) and 2.5 V (SBTN). In order to make these materials suitable for low-voltage applications where U=1-2 V, the layer thickness must be correspondingly reduced. However, this has failed hitherto because of the coarse-grained structure of the SBT and SBTN with grain sizes of up to 300 nm. With a small layer thickness, cavities form between the grains, into which cavities the material of the top electrode can penetrate and lead to short circuits with the bottom electrode. This effect already occurs with layer thicknesses of 120- 140 nm.

One possibility is to reduce the temperature of the so-called ferroanneal, i.e. a thermal annealing process during which the crystalline structure of the SBT forms, from typically 800° C. to e.g. 700° C. In this case, smaller grains typically form and the crystal structure is thus not as susceptible to the formation of cavities. This method has the disadvantage, however, of significantly lower values (up to 50%) for the remanent polarization 2P and electrical breakdown with greatly increasing leakage currents occurring already at U>2 V.

U.S. Pat. No. 5,831,299 describes a method for producing a ferroelectric capacitor having an upper and a lower thin electrode layer and a thin ferroelectric layer situated between the electrode layers. The ferroelectric thin layer has three individual layers in which at least one layer has a composition different from that of the other layers. The effect thereby achieved is that the ferroelectric capacitor has a sufficiently high remanent polarization and a sufficiently low coercive field strength and, at the same time, it is possible to set a relatively low ferroanneal temperature, that is to say significantly less than 800° C. However, the method becomes relatively complex as a result of the deposition of three ferroelectric layers having a different composition.

### SUMMARY OF THE INVENTION

It is accordingly an object of the invention to provide a method for producing a thin ferroelectric or paraelectric layer which overcomes the above-mentioned disadvantages of the heretofore-known layers of this general type and which, on the one hand, has a sufficiently high remanent polarization and, on the other hand, has a sufficient homogeneity without interfering cavities. In particular, it is an object of the invention to provide a method for producing a thin ferroelectric or paraelectric layer which is suitable for producing a ferroelectric or paraelectric capacitor.

With the foregoing and other objects in view there is provided, in accordance with the invention, a method for producing a polycrystalline metal-oxide-containing layer, the method includes the steps of:

providing a substrate;

forming a substantially amorphous metal-oxide-containing layer on the substrate;

carrying out a first thermal treatment such that the substantially amorphous metal-oxide-containing layer crystallizes during the first thermal treatment and a polycrystalline metal-oxide-containing layer is produced; applying a filling solution to the polycrystalline metal-oxide-containing layer for forming a filling layer, the filling layer covering the polycrystalline metal-oxide-containing layer and filling cavities formed during crystallization of the polycrystalline metal-oxide-containing layer; and layer crystallizes.

In other words, the invention describes a method for producing a polycrystalline metal-oxide-containing layer including the steps of:

providing a substrate;

forming an essentially amorphous metal-oxide-containing layer on the substrate;

carrying out a first thermal treatment, at a first temperature, during which the essentially amorphous metal-oxide-containing layer crystallizes and, as a result, a polycrystalline metal-oxide-containing layer is produced;

applying a filling solution to the polycrystalline metal-oxide-containing layer for the purpose of forming a filling layer, the filling layer covering the polycrystalline metal-oxide-containing layer and filling the cavities formed during the crystallization of the polycrystalline metal-oxide-containing layer; and

carrying out a second thermal treatment, at a second temperature, during which the filling layer crystallizes.

The invention thus makes it possible, after the formation of the essentially amorphous metal-oxide-containing layer, to carry out the first thermal treatment, that is to say the so-called ferroanneal, at a relatively high temperature, in particular at approximately 700° C.-800° C., and, in the process, to initially accept the formation of cavities. These cavities are then filled in a specific manner when the filling solution is applied to the recrystallized polycrystalline metal-oxide-containing layer. Afterward, the second thermal treatment is then carried out for the purpose of crystallizing the filling layer. This second thermal treatment is then preferably carried out at a lower temperature, for example approximately 700° C. or less, in order to avoid the formation of large grains in the filling layer.

The temperature of the first thermal treatment may thus lie between 700° C. and 800° C. and the temperature of the second thermal treatment may lie between 600° C. and 700° C.

In this case, the filling layer may be composed of the same material as the polycrystalline metal-oxide-containing layer.

The material used may be, for example, a ferroelectric such as SrBi₂Ta₂O₉ (SBT) or its variant SrBi₂(Ta₁₋ₓNbₓ)₂O₉ (SBTN) . It is also possible to use a paraelectric material.

However, it is also conceivable for the filling layer to be composed of a different material than the polycrystalline metal-oxide-containing layer.

As already described, the filling layer is deposited as an additional thin film on the coarse-grained metal-oxide-containing layer and, in the process, lines the cavities in the metal-oxide-containing layer and forms a planar surface in the ideal case. In order to avoid the formation of large grains in the filling layer, the latter is thermally treated at relatively low temperature. Accordingly, the filling layer has a remanent polarization which is approximately 30% less than the standard values, and a significantly improved leakage current behavior with breakdown voltages >8 V. The reduction of the remanent polarization compared with the standard values can be attributed at least partly to the presence of the thin planarizing layer on the surface of the metal-oxide-containing layer, which has a relatively low average grain size on account of the thermal treatment at relatively low temperature. Therefore, the invention can be improved still further if this planarizing layer is removed again from the surface and, consequently, remains only in the cavities. As a result, the series connection of material having high and low P (polarization) values becomes a parallel connection of the two materials, wherein the proportion of the material having a low P value corresponds to the spatial proportion of the cavities.

The removal of the thin layer from the surface can be brought about, for example, by etching back or by chemical mechanical polishing of the surface. As an alternative to this, a filling layer which only lines the cavities may be produced even from the outset through the use of a coating method with merely a planarizing effect, for example a spin-on method.

The metal-oxide-containing layer itself may be formed by the application of a main solution with subsequent drying. It may be provided that the substances used for forming the essentially amorphous metal-oxide-containing layer are contained both in the main solution and in the filling solution, the substances being present in a lower concentration in the filling solution compared with the main solution. In this case, the main solution is generally an organometallic precursor solution which is applied to the substrate by a spin-on method or by so-called Liquid Source Misted Chemical Deposition (LSMCD). After a multistage drying and driving out the organic components on a hot plate and also an RTP (rapid thermal processing) step, the substrates are then subjected to heat treatment at approximately 800° C. in order to form the crystalline structure of the metal-oxide-containing layer.

As the filling solution, a highly dilute precursor solution (0.06 M) is applied very thinly to the substrate. This layer is subsequently subjected to a hot plate treatment and RTP treatment. The RTP treatment is carried out at a somewhat lower temperature, e.g. approximately 700° C., in order to avoid the formation of large grains in the filling layer.

With the objects of the invention in view there is also provided, a microelectronic structure, including:

a substrate;

a polycrystalline metal-oxide-containing layer disposed on the substrate;

the polycrystalline metal-oxide-containing layer having a first side facing the substrate and a second side opposite the first side; and

the polycrystalline metal-oxide-containing layer containing predominantly coarse-grained crystallites on the first side and containing predominantly small-grained crystallites on the second side.

In other words, the invention also relates to a microelectronic structure having a substrate, and having a polycrystalline metal-oxide-containing layer on the substrate, the polycrystalline metal-oxide-containing layer predominantly including coarse-grained crystallites and small-grained crystallites distributed between the latter.

In this case, the coarse-grained crystallites are preferably at least twice as large as the small-grained crystallites and fill at least 80% of the volume of the polycrystalline metal-oxide-containing layer.

The polycrystalline metal-oxide-containing layer may be provided as a capacitor dielectric between two electrodes of a capacitor, in which case it is formed, in particular, from a ferroelectric or a paraelectric material. A ferroelectric material may be produced, for example, from SrBi₂Ta₂O₉ (SBT) or SrBi₂ (Ta₁₋ₓNbₓ)₂O₉ (SBTN)

In this way, the invention can be used for the production of a memory cell, such as a DRA memory cell.

Other features which are considered as characteristic for the invention are set forth in the appended claims.

Although the invention is illustrated and described herein as embodied in a method for producing very thin ferroelectric layers, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description is of specific embodiments when read in connection with the accompanying drawings.

### BRIEF DESCRIPTION OF THE DRAWINGS

FIGS. 1A-1D are diagrammatic sectional views of intermediate products of a method according to the invention, in which a metal-oxide-containing layer is applied on a substrate, and then a filling layer is applied;

FIG. 2 is a partial sectional view of a capacitor structure including electrodes and a dielectric layer disposed between the electrodes; and

FIG. 3 is a diagrammatic sectional view of an intermediate product of the method according to the invention for illustrating crystallites in the polycrystalline metal-oxide containing layer.

DESCRIPTION OF THE PREFERRED EMBODIMENTS

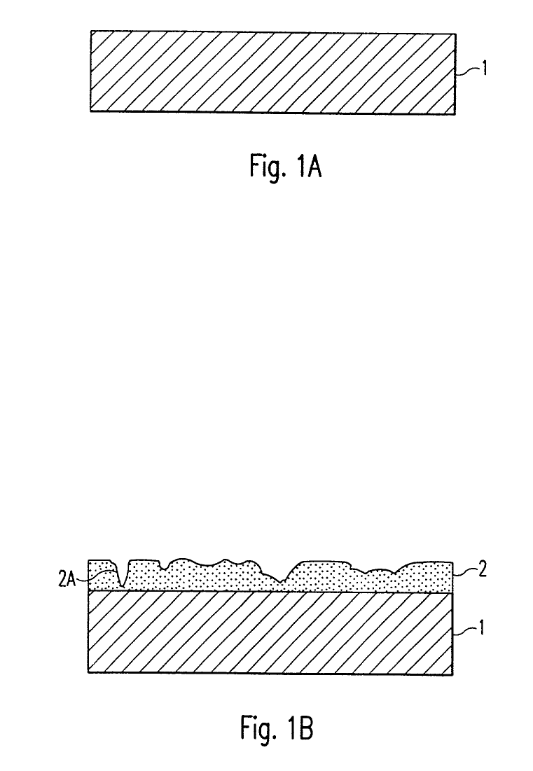

Referring now to the figures of the drawings in detail and first, particularly, to FIG. 1A thereof, there is shown that, at the beginning, basically an arbitrary substrate 1 is provided, to which a metal-oxide-containing layer 2 (see FIG. 1B) is to be applied. The substrate 1 may be, for example, the bottom electrode of a storage capacitor to be formed. For storage capacitors in which, as the metal-oxide-containing layer, a ferroelectric or paraelectric material is used as the dielectric, the electrodes are often produced from platinum or another platinum-group metal or one of their conductive oxides, such as RuO₂ for example. However, still other inert conductive materials are also conceivable, such as other conductive oxides, for example La-Sr-Co-O.

FIG. 1B shows how a metal-oxide-containing layer 2 is applied. This metal-oxide-containing layer may be, for example, a ferroelectric material such as SrBi₂Ta₂O₉ (SBT) or SrBi₂(Ta₁Nbₓ)₂O₉ (SBTN) . In order to produce an SBT layer, an organometallic precursor solution, for example, may be applied to the substrate 1 by a spin-on method or by LSMCD (Liquid Source Misted Chemical Deposition). After the drying of the applied liquid film, the metal-oxide-containing layer is initially present in the amorphous state. After a drying step, which is generally a multistage drying step, the organic components still present in the metal-oxide-containing layer may also additionally be driven out on a hot plate. Afterward, an RTP (rapid thermal processing) step may also be performed.

A thermal treatment step is then carried out at approximately 800° C. for approximately one hour in order to form the crystalline structure of the SBT material. In this case, it is shown that at such a high temperature of the thermal treatment step, relatively large grains of the SBT layer are formed, which lead to cavities 2A in the course of the thermal treatment process. If the applied metal-oxide-containing layer 2 is relatively thin, these cavities 2A can lead to short circuits between a top electrode deposited on the metal-oxide-containing layer 2 and the bottom electrode forming the substrate 1. This effect already occurs with layer thicknesses of 120-140 nm. However, it is a goal of the invention to maintain the high temperature of the thermal treatment of 800° C. on account of the high remanent polarization 2P that can thereby be obtained, and to solve the problem of the cavities 2A in another way.

FIG. 1C shows how, in order to solve this problem, a filling layer 3 is applied to the structure obtained. In this case, by way of example, a highly dilute solution (0.06 Mol) of the same precursor as used in the deposition of the SBT layer may be applied to the recrystallized SBT layer 2. This dilute solution accordingly has only a very low surface tension and penetrates relatively easily into the cavities 2A formed in the surface of the SBT layer 2. The filling layer 3 can also be applied by an LSMCD method, for example. The filling layer 3 is subsequently subjected to a hot plate and RTP treatment in order to dry it and to drive out the organic components of the solvent. Afterward, the filling layer 3 is also subjected to a thermal treatment process, a somewhat lower temperature than in the case of the SBT layer 2 being chosen here in order to avoid the formation of excessively large grains in the filling layer 3, in particular in the narrow cavities 2A. The result is a recrystallized filling layer 3 having relatively small-grained crystallites which, inter alia completely fill the cavities 2A of the SBT layer 2. It has been found that a filling layer, as in FIG. 1C, has a remanent polarization which is only approximately 30% less than the standard values. The layer composed of the layers 2 and 3 has a significantly improved leakage current behavior with breakdown voltages>8 V.

The reduction of the remanent polarization compared with the standard values can be attributed at least partly to the presence of the thin (20 nm) layer (heat-treated at a low temperature) on the surface of the SBT layer 2 (heat-treated at a high temperature). Therefore, in accordance with FIG. 1D, the invention can be improved still further if this thin layer is removed again from the surface and remains only in the cavities 2A. For this purpose, the filling layer 3 may be removed for example by chemical mechanical polishing (CMP). As an alternative, it may also be removed by etching back. It is even simpler, however, if the filling layer 3 is applied only as a planarizing layer from the outset. By way of example, the filling solution may be applied by a spin-on method, with the result that it only planarizes the surface of the SBT layer 2, the surface being provided with the cavities 2A. The drying and thermal treatment steps are subsequently performed, as described above. The necessity for performing a CMP (chemical mechanical polishing) step or etching back is then obviated. In all of the embodiments described, a structure of the kind illustrated in FIG. 1D is produced.

With the structure in FIG. 1D, the series connection of material having high and low P becomes a parallel connection of the two materials, the proportion of the material having a low P corresponding to the spatial (volume) proportion of the cavities 2A. The overall layer composed of the layers 2 and 3 thus exhibits only a small reduction in polarization, with a high electrical breakdown strength being obtained at the same time. A top electrode of a storage capacitor to be formed may be applied to the planar surface of the filling layer 3, as shown in FIG. 1C or 1D.

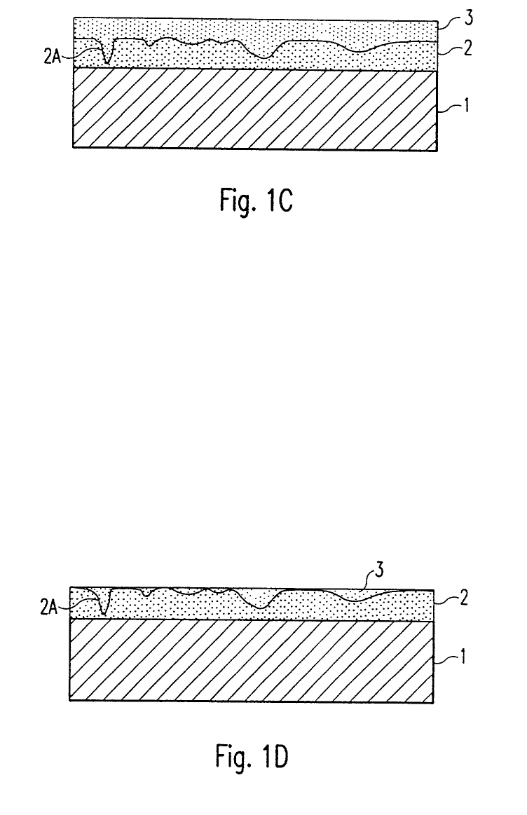

FIG. 2 is a partial sectional view of a capacitor structure including electrodes 4 and a dielectric layer disposed between the electrodes. The dielectric layer is formed of the polycrystalline metal-oxide-containing layer 2 according to the invention.

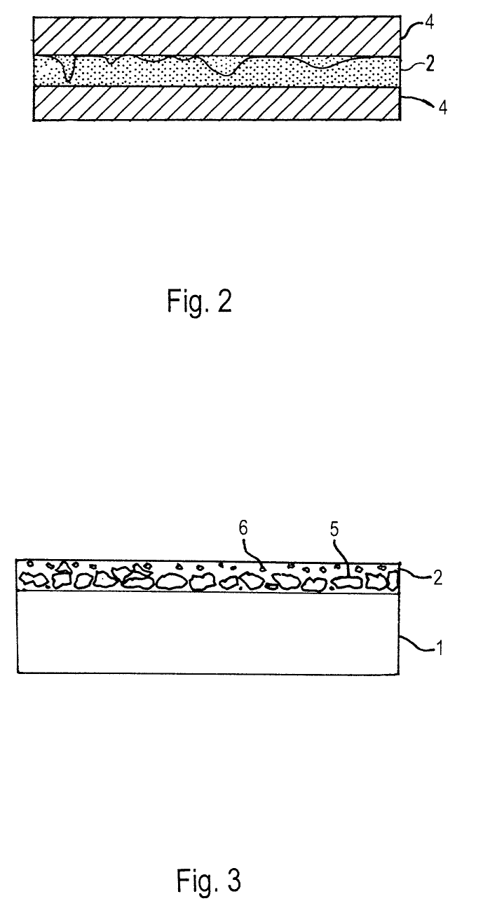

FIG. 3 is a diagrammatic sectional view of an intermediate product of the method according to the invention. The polycrystalline metal-oxide-containing layer 2 includes predominantly coarse-grained crystallites 5 on the substrate side and includes predominantly small-grained crystallites 6 on the opposite side. The coarse-grained crystallites 5 are preferably at least twice as large as the small-grained crystallites 6, and the coarse-grained crystallites preferably fill at least 80% of the volume of the polycrystalline metal-oxide-containing layer 2.

We claim:

1. A method for producing a polycrystalline metal-oxide-containing layer, the method which comprises:
providing a substrate;
forming a substantially amorphous metal-oxide-containing layer on the substrate;
carrying out a first thermal treatment such that the substantially amorphous metal-oxide-containing layer crystallizes during the first thermal treatment and a polycrystalline metal-oxide-containing layer is produced; applying a filling solution to the polycrystalline metal-oxide-containing layer for forming a filling layer, the filling layer covering the polycrystalline metal-oxide-containing layer and filling cavities formed during crystallization of the polycrystalline metal-oxide-containing layer; and
carrying out a second thermal treatment such that the filling layer crystallizes.

2. The method according to claim 1, which comprises forming the filling layer from a same material as the polycrystalline metal-oxide-containing layer.

3. The method according to claim 1, which comprises forming the substantially amorphous metal-oxide-containing layer by applying a main solution and performing a subsequent drying step.

4. The method according to claim 3, which comprises providing, in the main solution and in the filling solution, substances used for forming the substantially amorphous metal-oxide-containing layer such that the substances have a first concentration in the filling solution and have a second concentration in the main solution, the first concentration being smaller than the second concentration.

5. The method according to claim 1, which comprises carrying out the first thermal treatment at a first temperature and carrying out the second thermal treatment at a second temperature lower than the first temperature.

6. The method according to claim 1, which comprises carrying out the first thermal treatment at a first temperature between 700° C. and 800° C. and carrying out the second thermal treatment at a second temperature between 600° C. and 700° C.

7. The method according to claim 1, which comprises removing the filling layer except where the filling layer fills the cavities in the polycrystalline metal-oxide-containing layer.

8. The method according to claim 7, which comprises removing the filling layer with a chemical mechanical polishing step.

9. The method according to claim 7, which comprises removing the filling layer with an etch back step.

10. The method according to claim 1, which comprises forming the filling layer as a planarizing layer.

11. The method according to claim 1, which comprises forming the filling layer as a planarizing layer by using a spin-on process.

12. The method according to claim 1, which comprises applying the filling solution for forming the filling layer with a Liquid Source Misted Chemical Deposition process.

13. The method according to claim 1, which comprises forming the substantially amorphous metal-oxide-containing layer by applying a main solution with a spin-on process.

14. The method according to claim 1, which comprises forming the substantially amorphous metal-oxide-containing layer by applying a main solution with a Liquid Source Misted Chemical Deposition process.

15. The method according to claim 1, which comprises forming the polycrystalline metal-oxide-containing layer from a ferroelectric material.

16. The method according to claim 15, which comprises using, as the ferroelectric material, a material selected from the group consisting of SrBi₂Ta₂O₉ and SrBi₂(Ta₁₋ₓNbₓ)₂O₉, x being a positive real number.

17. The method according to claim 1, which comprises forming the polycrystalline metal-oxide-containing layer from a paraelectric material.

18. A microelectronic structure, comprising:
a substrate;
a polycrystalline metal-oxide-containing layer disposed on said substrate;
said polycrystalline metal-oxide-containing layer having a first side facing said substrate and a second side opposite said first side; and
said polycrystalline metal-oxide-containing layer containing predominantly coarse-grained crystallites on said first side and containing predominantly small-grained crystallites on said second side.

19. The microelectronic structure according to claim 18, wherein:
said polycrystalline metal-oxide-containing layer has a volume;
said coarse-grained crystallites are at least twice as large as said small-grained crystallites; and
said coarse-grained crystallites fill at least 80% of said volume of said polycrystalline metal-oxide-containing layer.

20. The microelectronic structure according to claim 18, wherein:
said substrate forms a first capacitor electrode; and
said polycrystalline metal-oxide-containing layer is disposed, as a capacitor dielectric, between said first capacitor electrode and a second capacitor electrode.

21. The microelectronic structure according to claim 18, wherein said metal-oxide-containing layer is formed of a ferroelectric material.

22. The microelectronic structure according to claim 18, wherein said metal-oxide-containing layer is a ferroelectric layer selected from the group consisting of a SrBi₂Ta₂O₉ layer and a SrBi₂(Ta₁₋ₓNbₓ)₂O₉ layer, x being a positive real number.

23. The microelectronic structure according to claim 18, wherein said metal-oxide-containing layer is formed of a paraelectric material.
